(19) United States
(12) Patent Application Publication
(10) Pub. No.: US 2018/0077901 A1
(43) Pub. Date: Mar. 22, 2018

(54) ACOUSTICALLY IMPROVED ANIMAL MEDICAL COLLAR ASSEMBLY

(71) Applicant: Chase Hallquist, South Haven, MN (US)

(72) Inventor: Chase Hallquist, South Haven, MN (US)

(21) Appl. No.: 15/272,548

(22) Filed: Sep. 22, 2016

(51) Int. Cl. A01K 13/00; A01K 27/00

(52) U.S. Cl. CPC A01K 13/006; A01K 27/001

(57) ABSTRACT

An acoustically improved animal medical collar assembly includes a panel that has a first side, a second side, an outer edge, an inner edge, a first lateral edge and a second lateral edge. The panel comprises a flexible material and the inner edge is concavely arcuate. The panel has a plurality of apertures extending therethrough. The apertures are distributed in grid pattern comprising hexagons where each of the apertures is positioned within one of the hexagons and surrounded by six of the hexagons which do not include apertures. Each hexagon without an aperture is abutted against and positioned between two of the hexagons each having one of the apertures. A closure is attached to the panel and releasably forms the panel into a cone shape.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

### (2) Description of Related Art Including Information Disclosed Under 37 CFR 1.97 and 1.98

The disclosure and prior art relates to animal medical cone devices and more particularly pertains to a new animal medical cone device for transmitting of sound through the cone and decreasing amplification of sound within the cone.

### BRIEF SUMMARY OF THE INVENTION

An embodiment of the disclosure meets the needs presented above by generally comprising a panel that has a first side, a second side, an outer edge, an inner edge, a first lateral edge and a second lateral edge. The panel comprises a flexible material and the inner edge is concavely arcuate. The panel has a plurality of apertures extending therethrough. The apertures are distributed in grid pattern comprising hexagons where each of the apertures is positioned within one of the hexagons and surrounded by six of the hexagons which do not include apertures. Each hexagon without an aperture is abutted against and positioned between two of the hexagons each having one of the apertures. A closure is attached to the panel and releasably forms the panel into a cone shape.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a front perspective view of a acoustically improved animal medical collar assembly according to an embodiment of the disclosure.

FIG. 2 is a rear perspective view of an embodiment of the disclosure.

FIG. 3 is a front in-use view of an embodiment of the disclosure.

FIG. 4 is a side view of an embodiment of the disclosure.

FIG. 5 is a front view of an embodiment of the disclosure.

FIG. 6 is a cross-sectional view of an embodiment of the disclosure taken along line 6-6 of FIG. 1.

### DETAILED DESCRIPTION OF THE INVENTION

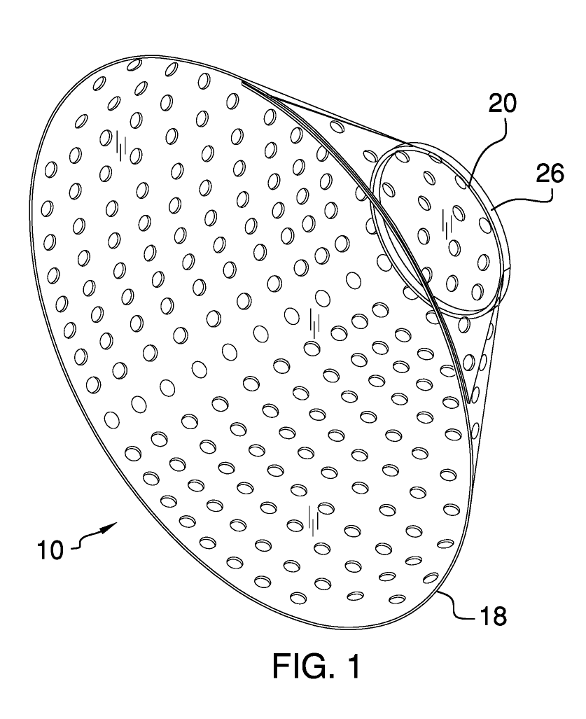

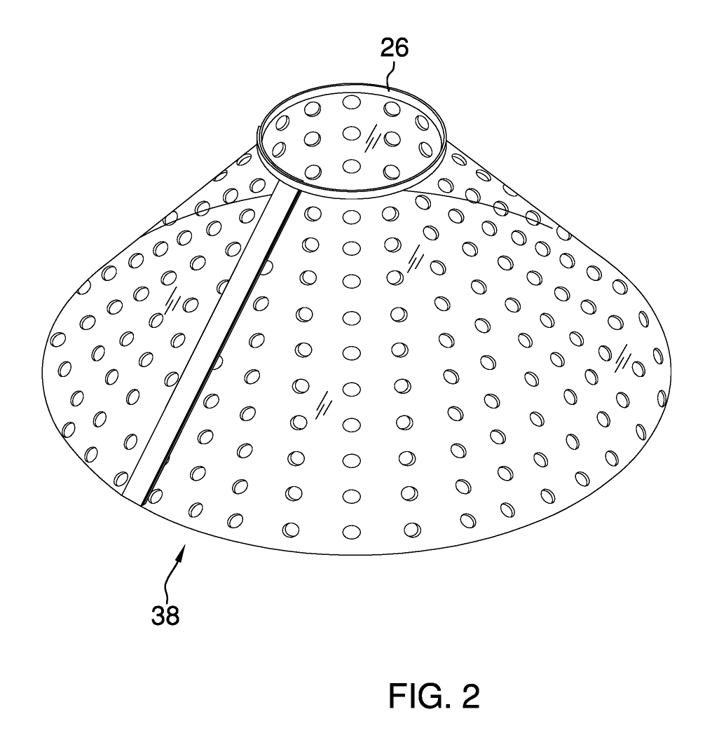

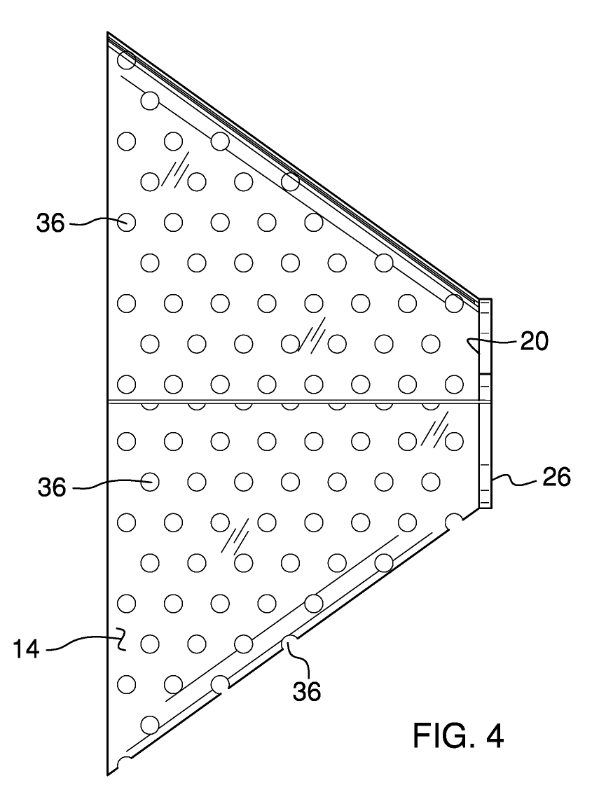

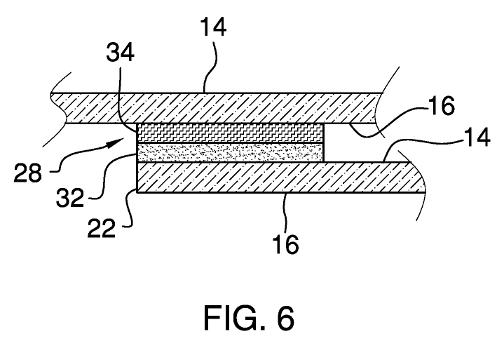

With reference now to the drawings, and in particular to FIGS. 1 through 6 thereof, a new animal medical cone device embodying the principles and concepts of an embodiment of the disclosure and generally designated by the reference numeral 10 will be described.

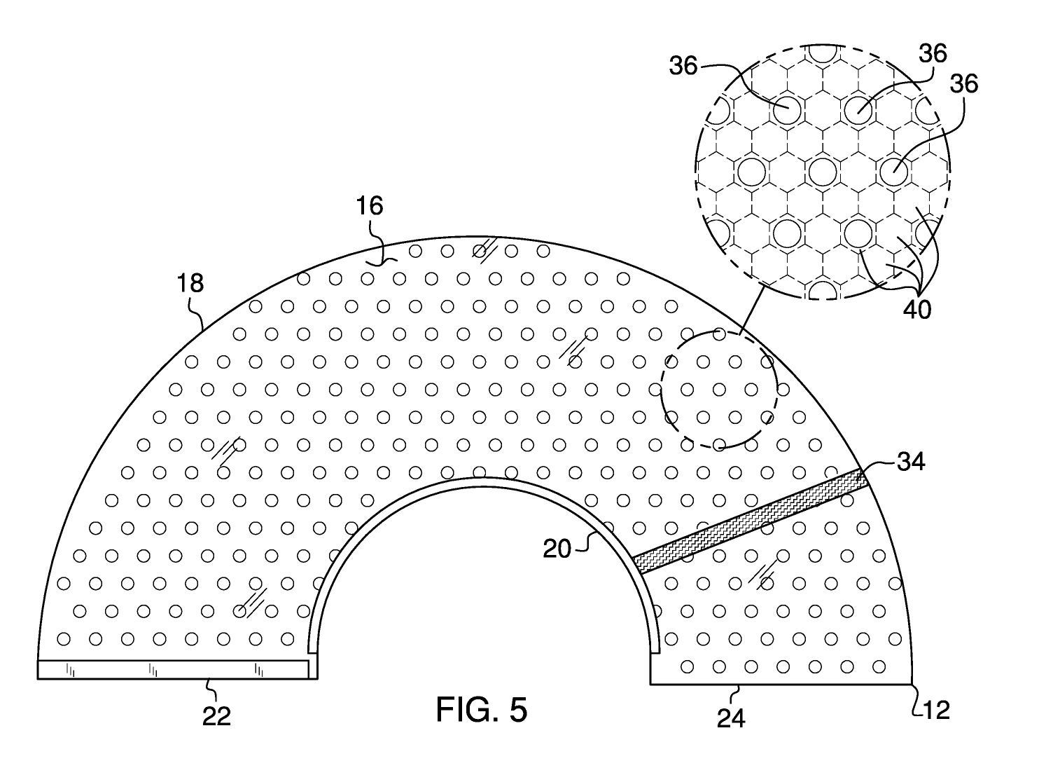

As best illustrated in FIGS. 1 through 6, the acoustically improved animal medical collar assembly 10 generally comprises a panel 12 that has a first side 14, a second side 16, an outer edge 18, an inner edge 20, a first lateral edge 22 and a second lateral edge 24. The panel 12 comprises a flexible material such as a resiliently flexible plastic material which may or may not be transparent but will typically be translucent. The inner edge 20 is concavely arcuate and the outer edge 18 may be convexly arcuate. As shown in FIG. 5, the outer 18 and inner 20 edges may form half circles through their lengths may be increased or decreased depending upon the type and size of animal the assembly 10 will be used with. Generally the inner 20 and outer 18 edges will form less than ¾ of a complete circle. A lip 26 may be attached to and extending along the inner edge 20 wherein the lip 26 extends away from the first side 14. The lip 26 may extend between 0.25 inches and 3.0 inches away from the panel 12.

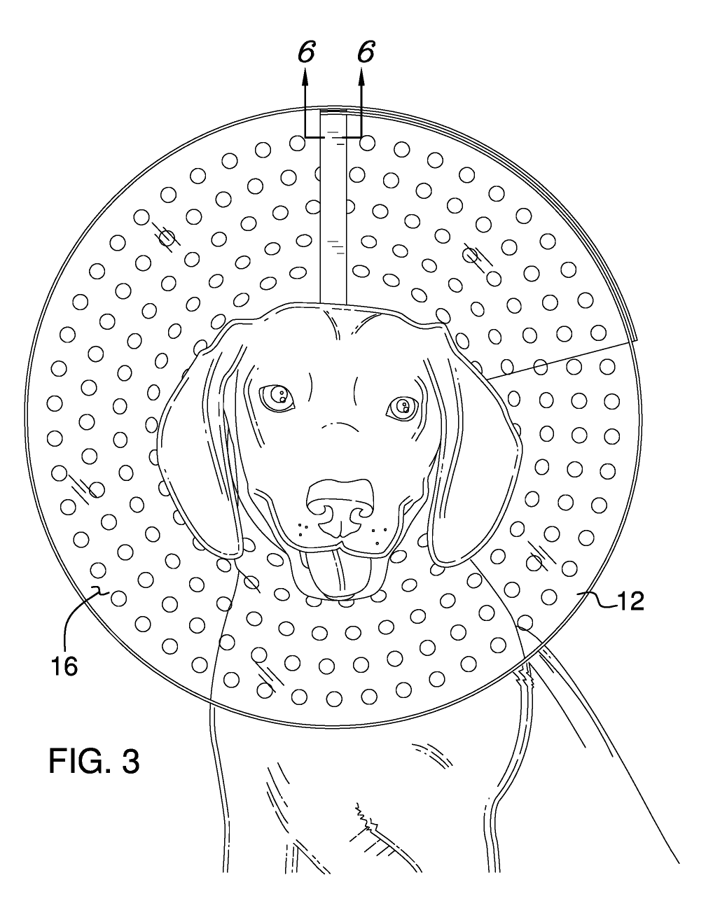

A closure 28 is attached to the panel 12 and releasably forms the panel 12 into a cone shape such that the panel 12 may be retained on the neck of an animal as shown in FIG. 3. The cone 28 prevents the animal from accessing an injury with their mouth to prevent further injury and/or access to bandages, stitches and the like. The closure 28 may include a first mating member 32 positioned near or adjacent to the first lateral edge 22 and a second mating member 34 positioned near or adjacent to the second lateral edge 24. The first 32 and second 34 mating members are releasably engaged to each other such that the second side 16 defines an interior of a cone, as shown in FIGS. 1-4. The first mating member 32 may be attached to the first side 14 and the second mating member 34 attached to the second side 16 and the closure 28 may further comprise a hook and loop coupler.

The panel 12 has a plurality of apertures 36 extending therethrough. Each of the apertures 36 is distributed in grid pattern comprising hexagons 40 where each of the apertures 36 is positioned within one of the hexagons 40 and surrounded by six of the hexagons 40 that are free of one of the apertures 36. Each hexagon 40 that is free of one of the apertures 36 is abutted against and positioned between two of the hexagons 40 which includes one of the apertures 36. The inset of FIG. 5 best shows this pattern. This pattern was selected as allowing the retention of structural integrity of the panel 12 while allowing for a large number of apertures 36 to be used.

The apertures 36 and their positioning have been found to allow sound to enter the cone 38 formed by the panel 12 from all directions and, more importantly, decreases the amplification of sounds entering the cone 38. This is important as canines and felines are easily startled by loud sounds and that the amplification of sounds could contribute to hearing damage. The following are test results demonstrating the lowering of the amplification properties of a conventional animal cone versus the assembly 10 (modified cone). The conventional and modified cone sound levels are taken from within the cone 38 adjacent to the inner edge 20 while the ambient measurements do not include the cone.
Test 1:
   Ambient Sound Outdoors: 70.88 dB
   Conventional Cone: 77.23 dB
   Modified Cone: 71.20 dB
Test 2:
   Ambient Alarm: 81.57 dB
   Conventional Cone: 89.53 dB
   Modified Cone: 82.04 dB
Test 3:
   Ambient Conversation: 71.68 dB
   Conventional Cone: 76.61 dB
   Modified Cone: 71.87 dB
Test 4:
   Ambient Television: 63.02 dB
   Conventional Cone: 67.02 dB
   Modified Cone: 62.27 dB
Test 5: Abrasion test wherein the cone was struck against an object in a manner similar to when an animal strikes a doorway or the like while wearing a cone. These tests were repeated 20 times for each of the modified and conventional cones and below are the averages:
   Conventional cone: 100.05 dB
   Modified cone: 89.34 dB

As can be seen from the above, the modified cone, i.e. the assembly 10, results in insignificant amounts of sound level increases. It is noted that Test 4 includes more than one speaker and therefore some sound would not be directed at the cone 38 but would be directed outside of the cone and therefore accounts for an actual decrease in dB. In addition to not overly amplifying sounds, sounds are also not decreased significantly when directed laterally at the assembly 10. This allows the animal to quickly identify the direction of the sound and therefore not startle the animal.

The apertures 36 themselves may have a circular shape; however hexagonal shapes may also be employed for the apertures. Each of the apertures 36 has a diameter equal to between 0.40 inches and 0.60 inches and may preferably have a diameter equal to 0.50 inches. The apertures 36 each have a center and adjacent ones of the centers are spaced from each other a distance between 1.25 inches and 1.40 inches. The distance between adjacent centers may be equal to 1.3125 inches (i.e. 1 5/16 inches).

In use, the panel 12 is extended around the head of an animal (dog, cat, horse, etc.) and secured in place with the closure. The panel 12 prevents the animal from accessing wounds while the apertures 36 allow for better sound transmission through the panel 12 while reducing sound amplification within the cone 38 formed by the panel 12 which promotes the well being of the animal.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. An animal protective collar assembly configured to be worn by an animal to prevent the animal from accessing a wound, said assembly comprising:
a panel having a first side, a second side, an outer edge, an inner edge, a first lateral edge and a second lateral edge, said panel comprising a flexible material, said inner edge being concavely arcuate;
said panel having a plurality of apertures extending therethrough, each of said apertures being distributed in grid pattern comprising hexagons where each of said apertures is positioned within one of said hexagons and surrounded by six of said hexagons being free of one of said apertures, each hexagon being free of one of said apertures being abutted against and positioned between two of said hexagons having one of said apertures; and
a closure being attached to said panel and releasably forming said panel into a cone shape.

2. The animal protective collar assembly according to claim 1, further including a lip being attached to and extending along said inner edge, said lip extending away from said first side.

3. The animal protective collar assembly according to claim 1, wherein each of said apertures has a circular shape.

4. The animal protective collar assembly according to claim 3, wherein each of said apertures has a diameter equal to between 0.40 inches and 0.60 inches.

5. The animal protective collar assembly according to claim 4, wherein each of said apertures has a center, adjacent ones of said centers being spaced from each other a distance between 1.25 inches and 1.40 inches.

6. The animal protective collar assembly according to claim 3, wherein each of said apertures has a center, adjacent ones of said centers being spaced from each other a distance between 1.25 inches and 1.40 inches.

7. The animal protective collar assembly according to claim 1, wherein said closure includes a first mating member positioned adjacent to said first lateral edge and a second mating member positioned adjacent to said second lateral edge, said first and second mating members being releasably engaged to each other such that said second side defines an interior of a cone.

8. An animal protective collar assembly configured to be worn by an animal to prevent the animal from accessing a wound, said assembly comprising:
a panel having a first side, a second side, an outer edge, an inner edge, a first lateral edge and a second lateral edge, said panel comprising a flexible material, said inner edge being concavely arcuate, said outer edge being convexly arcuate, a lip being attached to and extending along said inner edge, said lip extending away from said first side;
said panel having a plurality of apertures extending therethrough, each of said apertures being distributed in grid pattern comprising hexagons where each of said apertures is positioned within one of said hexagons and surrounded by six of said hexagons being free of one of said apertures, each hexagon being free of one of said apertures being abutted against and positioned between two of said hexagons having one of said apertures, each of said apertures having a circular shape;
each of said apertures having a diameter equal to between 0.40 inches and 0.60 inches;
each of said apertures having a center, adjacent ones of said centers being spaced from each other a distance between 1.25 inches and 1.40 inches; and
a closure being attached to said panel and releasably forming said panel into a cone shape, said closure including a first mating member positioned adjacent to said first lateral edge and a second mating member positioned adjacent to said second lateral edge, said first and second mating members being releasably engaged to each other such that said second side defines an interior of a cone.
